(19) United States
(12) Patent Application Publication
(10) Pub. No.: US 2015/0185346 A1
(43) Pub. Date: Jul. 2, 2015

(54) SYSTEM AND METHOD OF MITIGATING INSTABILITIES IN A PSEUDOACOUSTIC WAVE PROPAGATOR

(71) Applicants: Tamas Nemeth, San Ramon, CA (US); Raymond Ergas, San Clemente, CA (US); Kenneth Paul Bube, Seattle, WA (US)

(72) Inventors: Tamas Nemeth, San Ramon, CA (US); Raymond Ergas, San Clemente, CA (US); Kenneth Paul Bube, Seattle, WA (US)

(73) Assignee: Chevron U.S.A. Inc., San Ramon, CA (US)

(21) Appl. No.: 14/143,571

(22) Filed: Dec. 30, 2013

(51) Int. Cl. G01V 1/36; G01V 1/38; G01V 1/28; G01V 1/34; G01V 1/30

(52) U.S. Cl. CPC G01V 1/36; G01V 1/345; G01V 1/303; G01V 1/282; G01V 1/284; G01V 1/38

(57) ABSTRACT

A method is described that includes providing an earth model for a geologic medium having a tilted symmetry axis. The earth model includes a nonzero shear velocity in the direction of the symmetry axis for at least a subset of locations within the geologic medium. The method further includes processing seismic measurements using a set of pseudoacoustic equations applied and the earth model. The set of pseudoacoustic equations includes a first equation and a second equation describing the one or more seismic wavefields. The processing includes propagating the one or more seismic wavefields over a plurality of time-steps in accordance with the set of pseudoacoustic equations, determining whether a respective time-step of the plurality of time-steps meets predetermined criteria and, when the respective time-step meets the predetermined criteria, applying a set of constraints distinct from the earth model and the set of pseudoacoustic equations to adjust the one or more seismic wavefields.

### RELATED APPLICATION

This application relates to U.S. patent application Ser. No. 14/143,626, entitled “SYSTEM AND METHOD OF MITIGATING INSTABILITIES IN A PSEUDOACOUSTIC WAVE PROPAGATOR” filed Dec. 30, 2013, which is incorporated by reference in its entirety.

### TECHNICAL FIELD

The disclosed embodiments relate generally to techniques for seismic data acquisition, processing and interpretation during geophysical exploration, and more specifically to pseudoacoustic wave propagators for tilted transverse isotropic media.

### BACKGROUND

Seismic exploration involves surveying subterranean geological media for hydrocarbon deposits. Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

A survey typically involves deploying seismic source(s) and seismic sensor(s) at predetermined locations. The sources generate seismic waves, which propagate into a geological medium creating pressure changes and vibrations along their way. Variations in physical properties of the geological medium change the seismic waves, such as their direction of propagation and other properties. Parts of the seismic waves reach the seismic sensors. Some seismic sensors are sensitive to pressure changes (hydrophones), others to particle motion (e.g., geophones), and industrial surveys may deploy only one type of sensors or both. In response to the detected seismic waves, the sensors generate corresponding electrical signals and record them in storage media as seismic data.

Analysis of the seismic data can be performed to process the seismic data into an image of the geological medium. Reverse-time migration (RTM) propagates wavefields at the source locations into the geological medium forward in time and recorded wavefields at the receiver locations into the geological medium backward in time and then correlates the two types of wavefields to form an image of the geological medium. To reduce the computational cost of RTM while still allowing anisotropy, pseudoacoustic systems of differential equations are constructed that are less computationally expensive than using a fully elastic system. Some conventional approaches modify the dispersion relation for either the fully elastic system or a pseudoacoustic approximation (e.g., a 2×2 second-order pseudoacoustic systems of differential equations) by setting an S-wave velocity to be zero, and eliminating one or more corresponding terms in the pseudoacoustic system of differential equations. Unfortunately, because physical conservation laws may not be satisfied under such approximations, doing so can result in the introduction of instabilities. These instabilities arise from stationary noise that grows with time, thus making imaging of deeper layers or complex geological structures in the geological medium difficult. Moreover, it has been found that these instabilities can persist even when the S-wave velocity is artificially set to be greater than zero.

### SUMMARY

Accordingly, there is a need for wave propagators that mitigate or eliminate such instabilities. In accordance with some embodiments, a method is performed at an electronic device with one or more processors and memory. The method includes providing an earth model for a geologic medium. The geologic medium has a heterogeneous tilted symmetry axis, and the earth model includes a nonzero shear velocity in the direction of the symmetry axis for at least a subset of locations within the geologic medium. The electronic device processes one or more seismic measurements using a set of second-order pseudoacoustic equations applied in accordance with the earth model. The set of pseudoacoustic equations includes a first equation describing one or more seismic wavefields and a second equation describing the one or more seismic wavefields. The processing includes propagating the one or more seismic wavefields over a plurality of time-steps in accordance with the set of pseudoacoustic equations, determining whether a respective time-step of the plurality of time-steps meets predetermined criteria, and in accordance with a determination that the respective time-step meets the predetermined criteria, applying a set of constraints distinct from the earth model and the set of pseudoacoustic equations to adjust the one or more seismic wavefields.

In accordance with some embodiments, another method is performed at an electronic device with one or more processors and memory. The method includes providing an earth model for a geologic medium. The geologic medium has a heterogeneous tilted symmetry axis, and the earth model includes a nonzero shear velocity in the direction of the symmetry axis. The device processes one or more seismic measurements using a set of second-order pseudoacoustic equations applied in accordance with the earth model. The set of pseudoacoustic equations includes a first equation describing one or more seismic wavefields and a second equation describing the one or more seismic wavefields. The processing includes propagating the one or more seismic wavefields over a plurality of time-steps in accordance with the set of pseudoacoustic equations. Propagating the one or more seismic wavefields includes calculating the one or more seismic wavefields at a plurality of locations within the geologic medium. For a subset of the plurality of locations within the geologic medium, upon completion of each time-step in the plurality of time-steps, the device applies a set of constraints distinct from the earth model and the set of pseudoacoustic equations to adjust the one or more seismic wavefields.

In accordance with some embodiments, another method is performed at an electronic device with one or more processors and memory. The method includes receiving one or more seismic measurements corresponding to a plurality of source and receiver locations. The method further includes providing an earth model for a geologic medium. The geologic medium has a heterogeneous tilted symmetry axis and the earth model includes a nonzero shear velocity in the direction of the symmetry axis for at least a subset of locations within the geologic medium. The method still further includes propagating the one or more seismic measurements over a plurality of time-steps in accordance with the earth model and a set of energy-conservative pseudoacoustic equations. The set of energy-conservative pseudoacoustic equations includes a first equation describing one or more seismic wavefields and a second equation describing the one or more seismic wavefields. The set of energy-conservative pseudoacoustic equations is derived from a set of energy non-conservative pseudoacoustic equations by approximating one or more derivative terms of the one or more seismic wavefields in the set of energy non-conservative pseudoacoustic equations.

In another aspect of the present invention, to address the aforementioned problems, some embodiments provide a non-transitory computer readable storage medium storing one or more programs. The one or more programs comprise instructions, which when executed by an electronic device with one or more processors and memory, cause the electronic device to perform any of the methods provided herein.

In yet another aspect of the present invention, to address the aforementioned problems, some embodiments provide an electronic device. The electronic device includes one or more processors, memory, and one or more programs. The one or more programs are stored in memory and configured to be executed by the one or more processors. The one or more programs include an operating system and instructions that when executed by the one or more processors cause the electronic device to perform any of the methods provided herein.

### BRIEF DESCRIPTION OF THE DRAWINGS

FIG. 1 is a schematic diagram of a marine seismic data acquisition environment, in accordance with some embodiments.

FIG. 2 is a block diagram illustrating a seismic modeling system, in accordance with some embodiments.

FIGS. 3A-3D is a schematic flowchart of a method of mitigating instabilities in a pseudoacoustic model, in accordance with some embodiments.

FIG. 4 is a schematic flowchart of another method of mitigating instabilities in a pseudoacoustic model, in accordance with some embodiments.

FIG. 5 illustrates several simulated wavefield snapshots calculated in accordance with some embodiments.

FIG. 6 illustrates several simulated wavefield snapshots calculated in accordance with some embodiments.

FIG. 7 illustrates several simulated pre-stack images calculated in accordance with some embodiments.

FIGS. 8A-C are a schematic flowchart of another method of mitigating instabilities in a pseudoacoustic model, in accordance with some embodiments.

Like reference numerals refer to corresponding parts throughout the drawings.

### DETAILED DESCRIPTION OF EMBODIMENTS

Described in more detail below is a method of modeling a wavefield in a geologic medium that mitigates and/or eliminates the instabilities associated with pseudoacoustic approximations to the fully elastic wave equation. In accordance with some embodiments, an earth model for a geologic medium (sometimes called a “velocity model”) is provided that specifies various characteristics of a geologic medium, such a shear (S) wave velocities, compressional (P) wave velocities, stiffness parameters (e.g., a stiffness tensor) and/or anisotropy parameters (e.g., a dip angle or Thomsen parameter δ), and density for a plurality of locations within the geologic medium (e.g., locations specified by a computational grid). The earth model includes a nonzero shear velocity in the direction of the symmetry axis for at least a subset of locations within the geologic medium (e.g., where it is geologically helpful). Based on the earth model, one or more seismic wavefields is propagated (e.g., time-stepped) over a plurality of time-steps using pseudoacoustic approximations to the fully elastic wave equation. In some embodiments, each wavefield represents a value of a respective state variable at each location in the geologic medium (e.g., each location on a computational grid). For simplicity, the terms “wavefield” and “state variable,” and “seismic wavefield” are, in some embodiments, used interchangeably herein.

In some embodiments, for select locations within the geologic medium (e.g., locations comprising a salt or water medium that does not support shear waves), a set of constraints (e.g., constraints consistent with an elliptical anisotropy) is applied to “reset” the seismic wavefields and thereby prevent unstable aspects of the seismic wavefields from growing beyond an acceptable level. Alternatively, or in addition to, in some embodiments, the “reset” operation is applied to some or all locations within the geologic medium in accordance with time-step criteria (e.g., all locations in the geologic medium are reset every 1,000 time-steps). Still alternatively, or still in addition to, the pseudoacoustic approximations comprise a set of energy-conservative pseudoacoustic equations (e.g., coupled equations) that is derived from a set of energy non-conservative pseudoacoustic equations (e.g., coupled equations) by approximating one or more derivative terms of the seismic wavefields in the set of energy non-conservative pseudoacoustic equations.

Reference will now be made in detail to various embodiments, examples of which are illustrated in the accompanying drawings. In the following detailed description, numerous specific details are set forth in order to provide a thorough understanding of the present disclosure and the described embodiments herein. However, embodiments described herein may be practiced without these specific details. In other instances, well-known methods, procedures, components, and mechanical apparatus have not been described in detail so as not to unnecessarily obscure aspects of the embodiments.

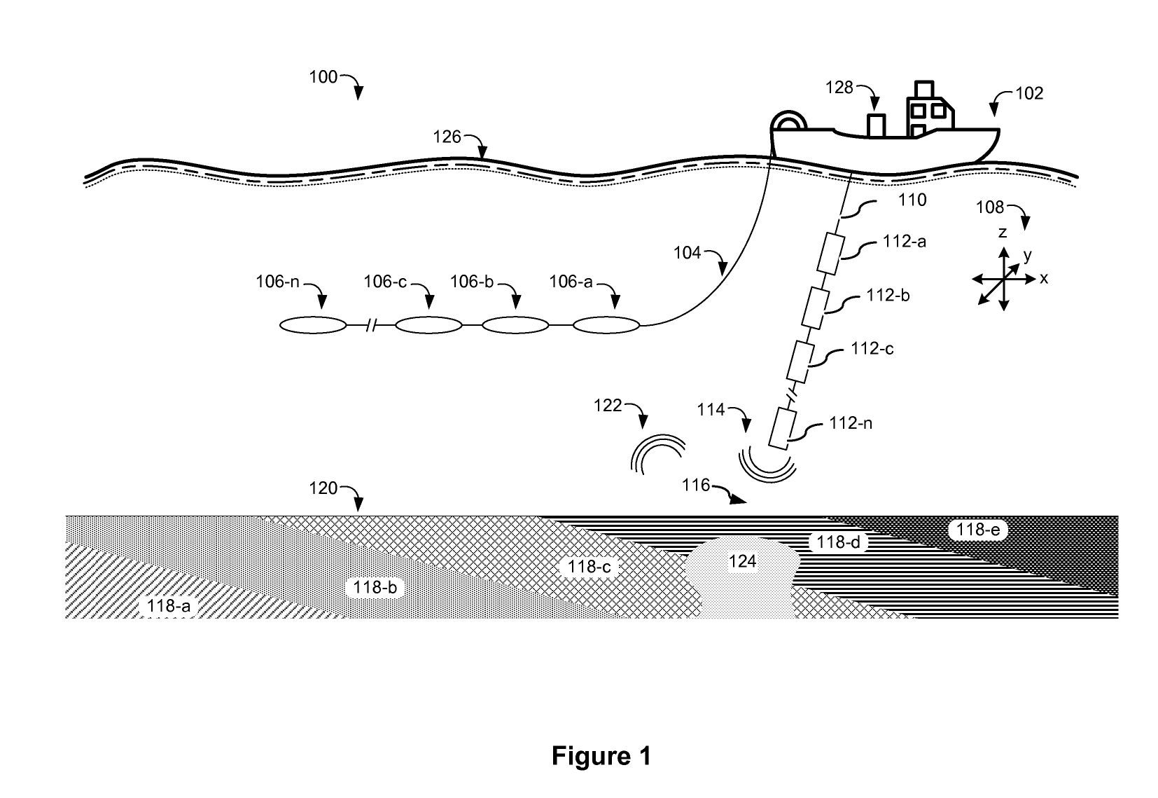

FIG. 1 is a schematic diagram of a marine seismic data acquisition environment 100, in accordance with some embodiments. In the environment 100, a survey vessel 102 tows one or more seismic streamers (one exemplary streamer 104 being depicted in FIG. 1) behind the vessel 102. The seismic streamers 104 may be several thousand meters long and may contain various support cables (not shown), as well as wiring and/or circuitry (not shown) that may be used to support communication along the streamers 104. In general, a streamer 104 includes a primary cable onto which seismic sensors 106 are mounted (e.g., seismic sensor 106-a, 106-b, 106-c through seismic sensor 106-n) that record seismic signals.

In some embodiments, the seismic sensors 106 may be pressure sensors only or may be multi-component seismic sensors. For the case of multi-component seismic sensors, each sensor is capable of detecting a pressure wavefield and at least one component of a particle motion that is associated with acoustic signals that are proximate to the multi-component seismic sensor. Examples of particle motions include one or more components of a particle displacement (e.g., one or more of an inline (x), a crossline (y) and/or a vertical (z) component as shown in axes 108, for example), one or more components of a particle velocity, and one or more components of a particle acceleration.

In some embodiments, the multi-component seismic sensor may include one or more hydrophones, geophones, particle displacement sensors, particle velocity sensors, accelerometers, pressure gradient sensors, or a combination thereof.

For example, in some embodiments, a particular multi-component seismic sensor may include a hydrophone for measuring pressure and three orthogonally-aligned accelerometers to measure three corresponding orthogonal components of particle velocity and/or acceleration near the seismic sensor. It is noted that the multi-component seismic sensor may be implemented as a single device or may be implemented as a plurality of devices. A particular multi-component seismic sensor may also include one or more pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, at a particular point, seismic data indicative of the pressure data with respect to the inline direction.

The marine seismic data acquisition environment 100 includes one or more seismic source arrays 110. A source array 110, in turn, includes one or more strings of seismic sources such as air guns (e.g., seismic source 112-a, 112-b, 112-c through seismic source 112-n). In some embodiments, the seismic sources 112 may be coupled to, or towed by, the survey vessel 102. Alternatively, the seismic sources 112 may operate independently of the survey vessel 102, in that the source elements 112 may be coupled to, for example, other vessels or buoys.

As the seismic streamers 104 are towed behind the survey vessel 102, acoustic signals 114 (sometimes referred to as “shots”) are produced by the seismic sources 112 and are directed down through a water column 116 into strata 118 (e.g., strata 118-a, 118-b, 118-c, 118-d, and 118-e each represent a respective layer of the geological medium) beneath a water bottom surface 120. Reflected acoustic signals 122 are reflected from the various subterranean geological features, such as an exemplary formation 124 (e.g., a salt dome).

The incident acoustic signals 114 produce corresponding reflected acoustic signals, or pressure waves, which are sensed by the seismic sensors 106. It is noted that the pressure waves that are received and sensed by the seismic sensors 106 include “up-going” pressure waves that propagate to the sensors 106 without reflection, as well as “down-going” pressure waves that are produced by reflections of the pressure waves from an air-water boundary 126.

The seismic sensors 126 generate signals (digital signals, for example), called “traces,” which indicate the acquired measurements of the pressure wavefield and particle motion (if the sensors are particle motion sensors). The traces are recorded and may be at least partially processed by a signal processing unit 128 that is deployed on the survey vessel 102, in accordance with some embodiments.

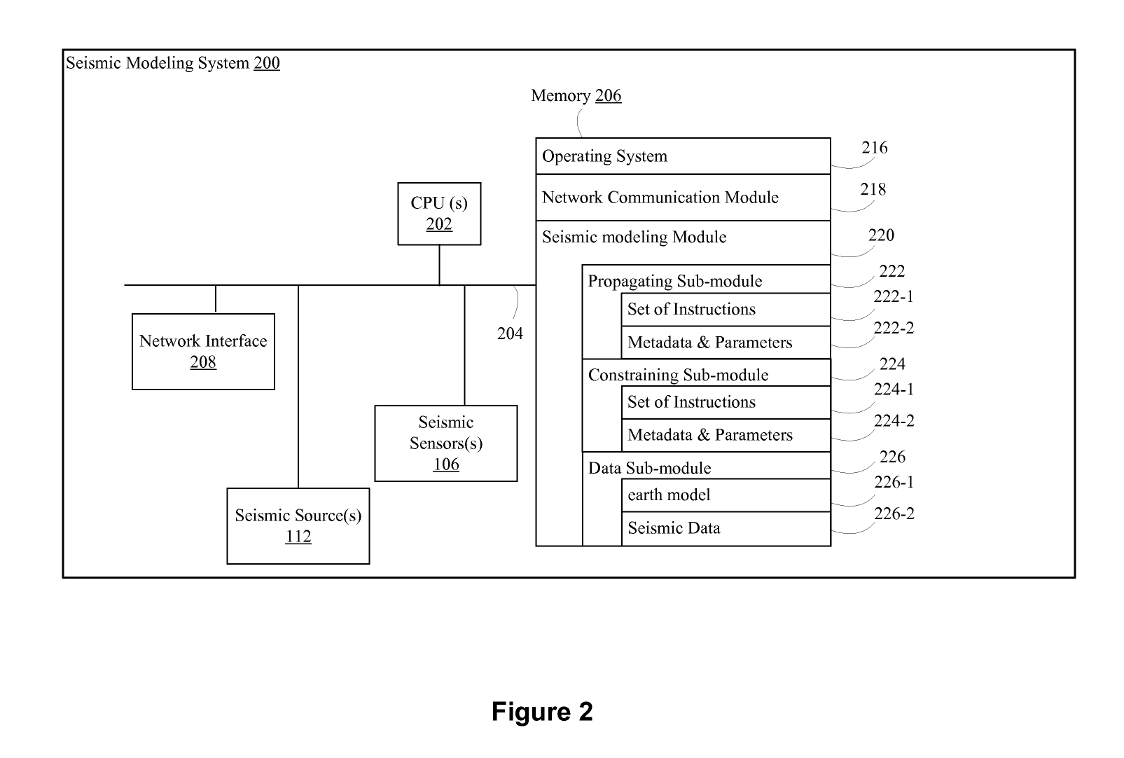

The goal of the seismic acquisition is to build up an image of a survey area for purposes of identifying subterranean geological media, such as the exemplary geological formation 124 (e.g., a salt dome). Subsequent analysis of the representation may reveal probable locations of hydrocarbon deposits in subterranean geological media. In some embodiments, portions of the analysis of the representation may be performed on the seismic survey vessel 102, such as by the signal processing unit 128. In some embodiments, the representation may be processed by a seismic modeling system (such as an exemplary seismic modeling system 200 that is depicted in FIG. 2 and is further described below) that may be, for example, located on land or on the vessel 102. Thus, many variations are possible and are within the scope of the appended claims.

One of ordinary skill in the art will appreciate that the marine seismic data acquisition environment 100 described above is merely an example of one of many different types of seismic data acquisition environments that may be used. For example, in some embodiments, the seismic data acquisition environment may use stationary sensor cables that are disposed on the seabed. As another example, in some embodiments, the seismic data acquisition environment may be a land-based environment in which sensor cables are buried in the earth. Thus, many variations are contemplated and are within the scope of the appended claims.

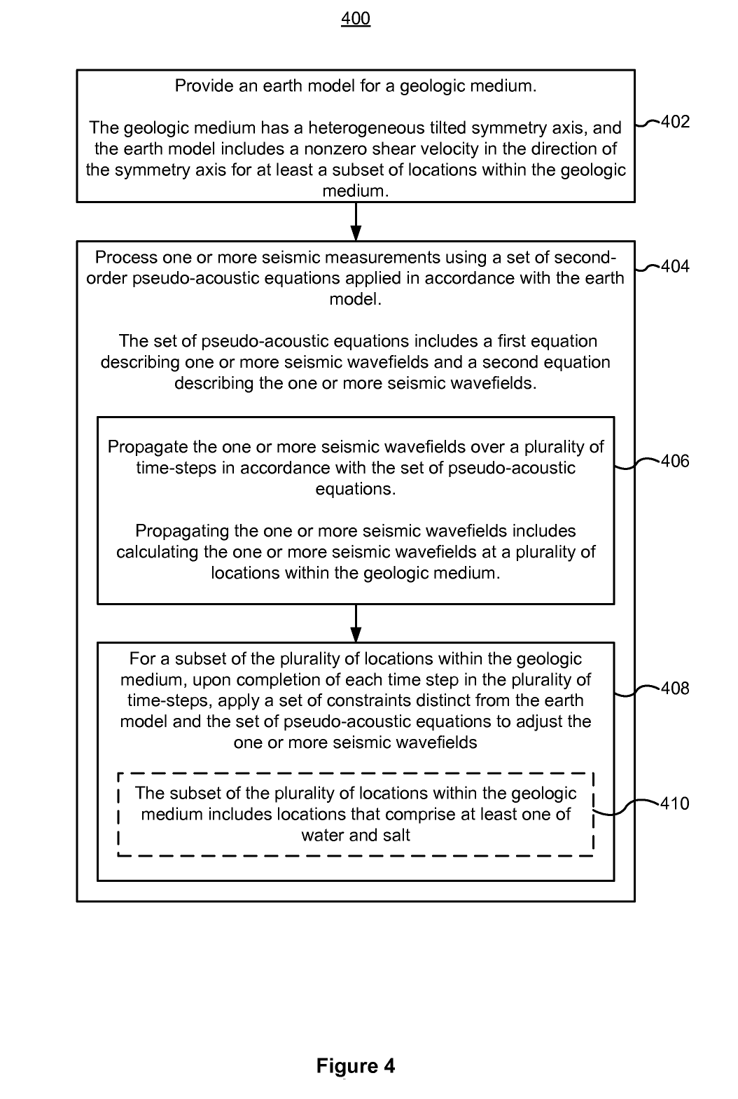

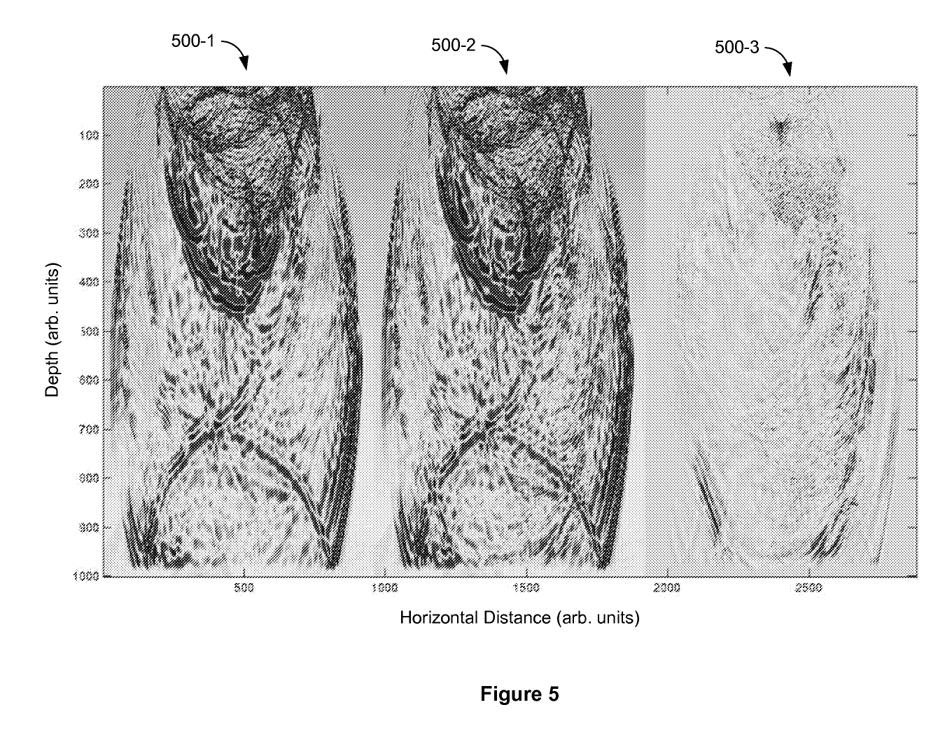

Seismic migration is a process that is typically used for purposes of imaging the reflectivity distribution in the earth. In some embodiments, seismic migration involves propagating (e.g., time-stepping) the signals that are recorded at the seismic sensors backwards in time to calculate one or more wavefields at the corresponding reflection points. In some embodiments, seismic migration also involves propagating (e.g., time-stepping) the signals that are produced at the seismic sources forward in time to calculate the wavefields at the corresponding reflection points. Seismic migration may be complicated by seismic anisotropy (e.g., a tilted transverse anisotropy with a steep or heterogeneous direction of a symmetry axis), which can introduce instabilities in the backward and forward propagation of the respective signals, thereby undermining the imaging process. Described in more detail below are systems and methods that mitigate or eliminate these instabilities by resetting the wavefields at certain propagation times and/or locations within the geologic medium (e.g., method 400, FIG. 4 and/or method 500, FIG. 5). Also described in more detail below are systems and method and methods that mitigate or eliminate these instabilities by using an energy-conservative pseudoacoustic propagator (e.g., set of pseudoacoustic equations) to propagate the wavefields.

FIG. 2 is a block diagram illustrating a seismic modeling system 200, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the seismic modeling system 200 includes one or more processing units (CPU's) 202, one or more network or other communications interfaces 208, memory 206, and one or more communication buses 204 for interconnecting these and various other components. The seismic modeling system 200 also optionally includes one or more seismic sensors 106 (e.g., geophones and/or hydrophones), one or more seismic sources 112 (e.g., air-guns). The communication buses 204 may include circuitry (sometimes called a chipset) that interconnects and controls communications between system components. Memory 206 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the CPU(s) 202. Memory 206, including the non-volatile and volatile memory device(s) within memory 206, comprises a non-transitory computer readable storage medium.

In some embodiments, memory 206 or the non-transitory computer readable storage medium of memory 206 stores the following programs, modules and data structures, or a subset thereof including an operating system 216, a network communication module 218, a seismic modeling module 220.

The operating system 216 includes procedures for handling various basic system services and for performing hardware dependent tasks.

The network communication module 218 facilitates communication with other devices (e.g., facilitates communication with the seismic sources 112 and/or the seismic sensors 106 if not included in the system 200, or facilitates communication with other land-based components) via the communication network interfaces 208 (wired or wireless) and one or more communication networks, such as the Internet, other wide area networks, local area networks, metropolitan area networks, and so on (e.g., in some embodiments, seismic modeling system 200 is located remotely from the seismic sources 112 and/or seismic sensors 106).

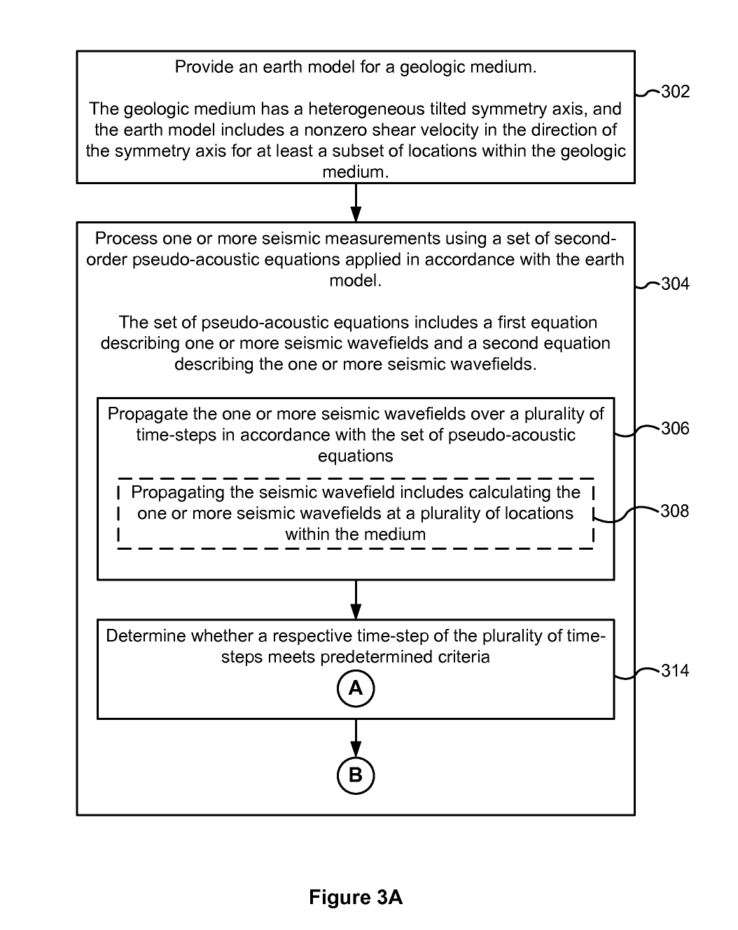

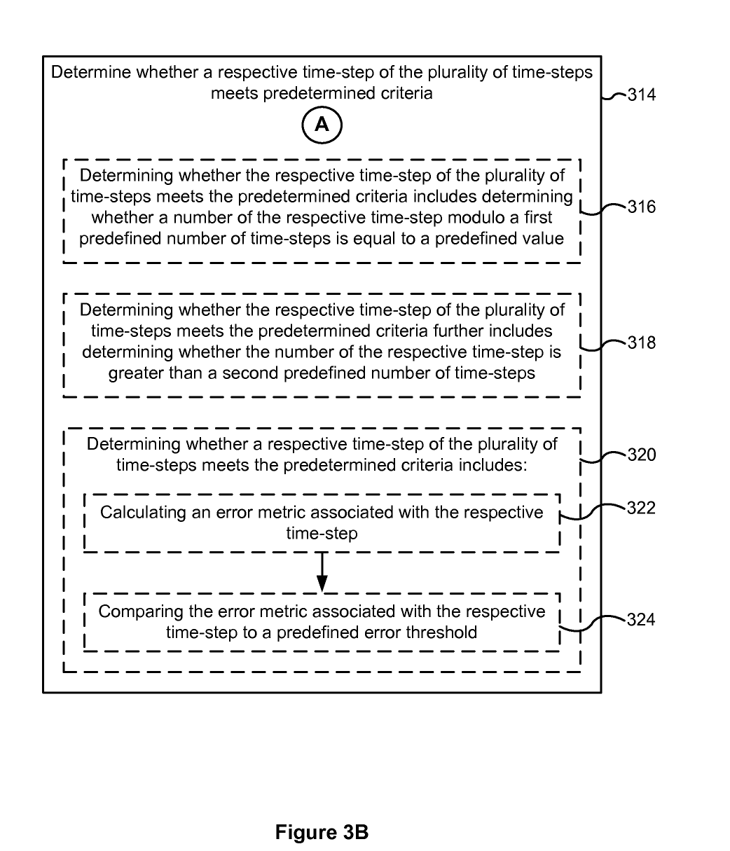

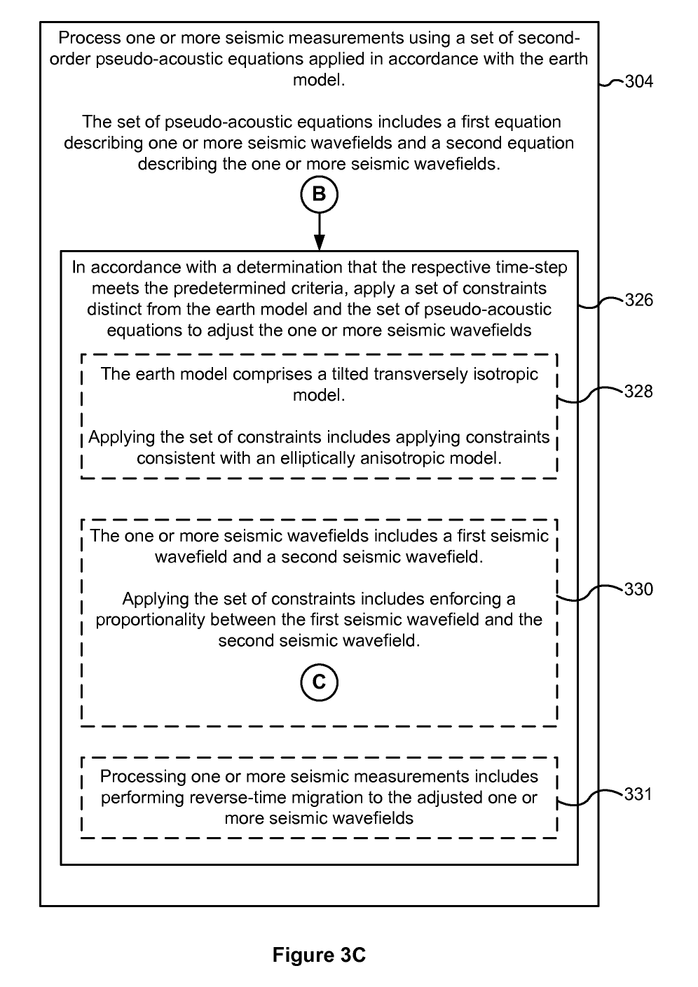

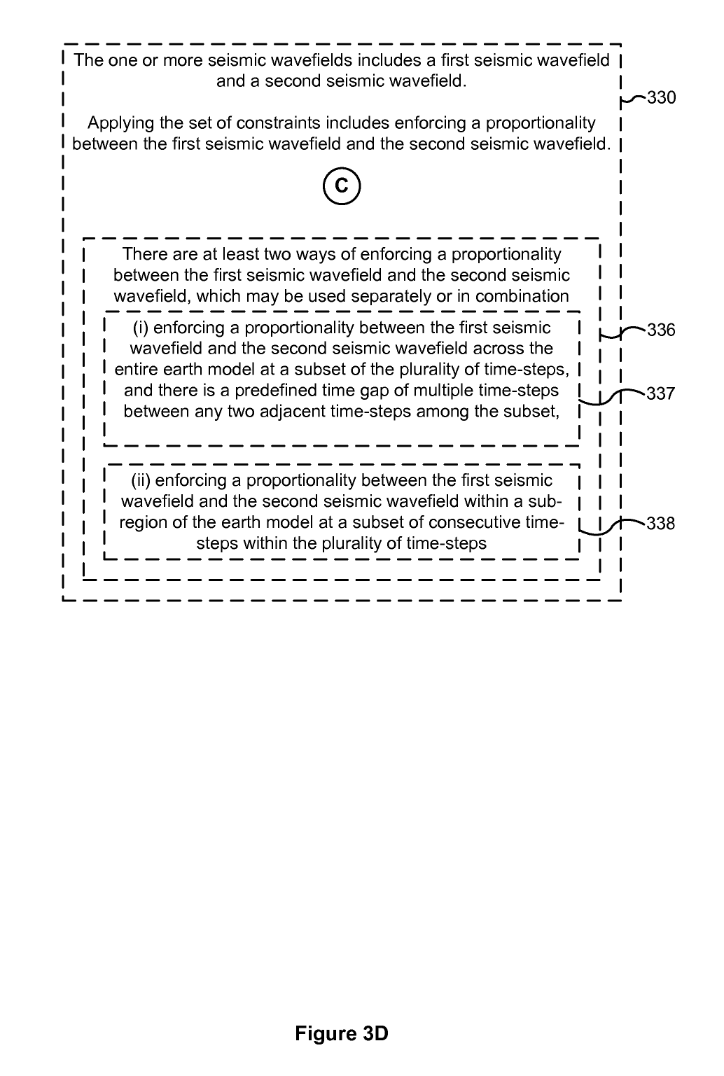

In some embodiments, the seismic modeling module 220 is configured to receive an earth model for a geologic medium. The seismic modeling module 220 processes one or more seismic measurements (e.g., received from seismic sensors 106) using a set of second-order pseudoacoustic equations applied in accordance with the earth model to calculate one or more seismic wavefields. The seismic modeling module 220 propagates the seismic wavefields over a plurality of time-steps in accordance with the set of pseudoacoustic equations. In accordance with predetermined criteria (described below with reference to method 300, FIG. 3, and method 400, FIG. 4), the seismic modeling module 220 applies a set of constraints (e.g., elliptical constraints or isotropic constraints) to adjust (or “reset”) the seismic wavefields.

To that end, the seismic modeling module 220 optionally includes one or more sub-modules, each including a set of instructions and optionally including metadata and parameters. For example, in some embodiments, the seismic modeling module 220 propagates the seismic wavefields using a propagating sub-module 224 (which includes a set of instructions 224-1 and metadata and parameters 224-2, where the metadata and parameters may include a time-step duration), applies the set of constraints to the seismic wavefields using a constraining sub-module 222 (which includes a set of instructions 222-1 and metadata and parameters 222-2) and stores data in a data sub-module 226 (which includes an earth model 226-1 and seismic data 226-2)

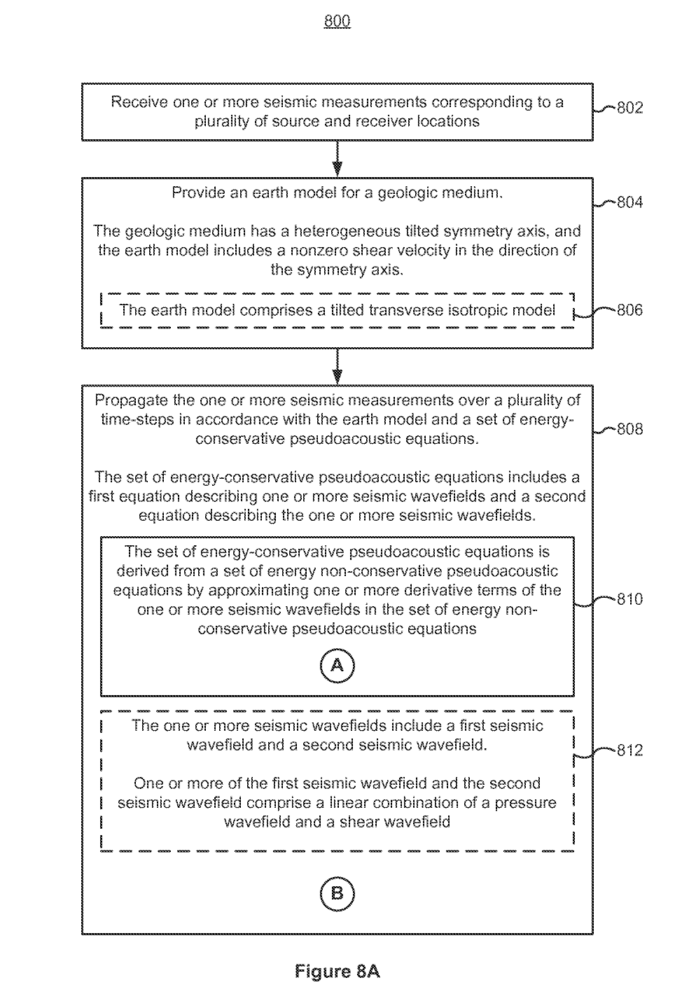

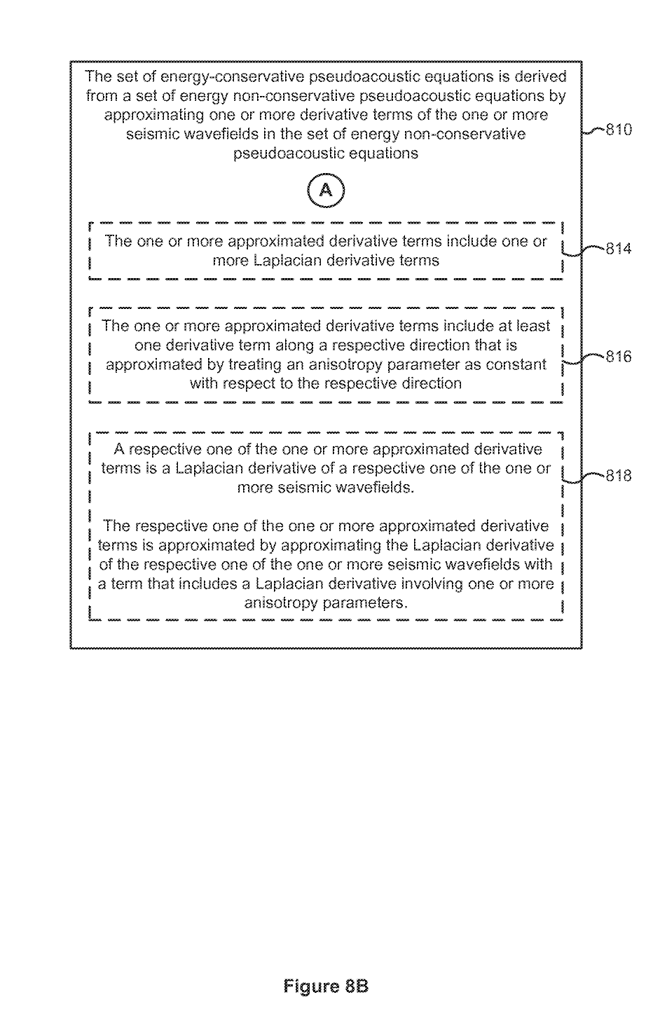

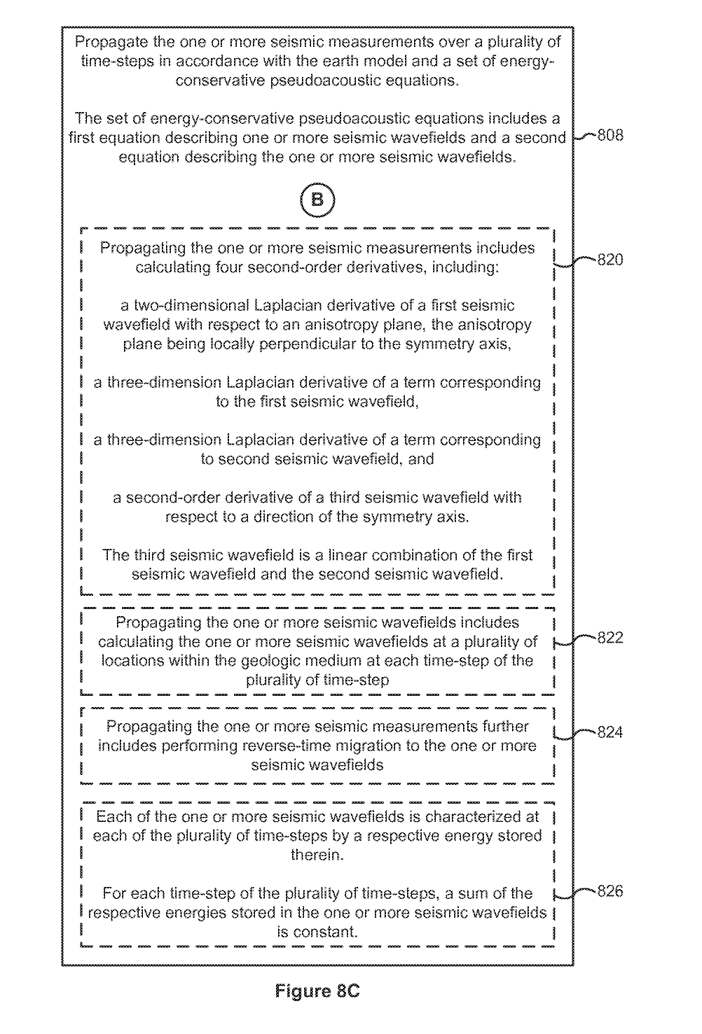

FIGS. 3A-3D is a schematic flowchart of a method 300 of mitigating instabilities in a pseudoacoustic model, in accordance with some embodiments. The method is, optionally, governed by instructions that are stored in computer memory or a non-transitory computer readable storage medium (e.g., memory 212 in FIG. 2) and that are executed by one or more processors (e.g., processor(s) 202) of one or more computer systems, including, but not limited to, signal processing unit 128 (FIG. 1) and/or system 200 (FIG. 2). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various embodiments, some operations in each method may be combined and/or the order of some operations may be changed from the order shown in the figures. Also, in some embodiments, operations shown in separate figures and/or discussed in association with separate methods (e.g., method 400, FIG. 4 and/or method 800, FIGS. 8A-8C) may be combined to form other methods, and operations shown in the same figure and/or discussed in association with the same method may be separated into different methods. Moreover, in some embodiments, one or more operations in the methods are performed by modules of system 200 shown in FIG. 2, including, for example, processor(s) 202, seismic modeling module 220, memory 212, network interface 210, and/or any sub modules thereof.

The seismic modeling system provides (302) an earth model for a geologic medium. The geologic medium has a heterogeneous tilted symmetry axis, and the earth model includes a nonzero shear velocity in the direction of the symmetry axis for at least a subset of locations within the geologic medium. The earth model may include any combination of pressure wave and shear wave velocities, anisotropy parameters (e.g., a direction of the symmetry axis, sometimes called a “dip angle”) and/or one or more values of a stiffness tensor C at a plurality of locations in the geologic medium (e.g., at each location in a computational grid). In some embodiments, C is a diagonal 6×6 stiffness tensor related to the Thomsen parameters δ and ε in that:

$$\begin{matrix}C = [ \begin{matrix}{C}_{11} & {C}_{11} - 2 {C}_{66} & {C}_{13} & 0 & 0 & 0 \\ {C}_{11} - 2 {C}_{66} & {C}_{11} & {C}_{13} & 0 & 0 & 0 \\ {C}_{13} & {C}_{13} & {C}_{33} & 0 & 0 & 0 \\ 0 & 0 & 0 & {C}_{44} & 0 & 0 \\ 0 & 0 & 0 & 0 & {C}_{44} & 0 \\ 0 & 0 & 0 & 0 & 0 & {C}_{66}\end{matrix} ] \\ where & ( 1 ) \\ {C}_{33} = ρ {V}_{pz}^{2} & ( 2 ) \\ {C}_{11} = ( 1 + 2 ε ) {C}_{33} & ( 3 ) \\ {C}_{13} = ( \sqrt{f ( f + 2 δ )} - ( 1 - f ) ) {C}_{33} & ( 4 ) \\ {C}_{44} = ( 1 - f ) {C}_{33} & ( 5 )\end{matrix}$$

All other elements of the stiffness tensor C including C₆₆ are equal to zero. And, f is a so-called “f-factor” given by:

ƒ=1−V_{SZ}²/V_{PZ}² (6)

which relates to a shear wave velocity in the vertical direction, V_{SZ} and a pressure wave velocity in the vertical direction V_{PZ}. As used herein, vertical and horizontal are defined with respect to the anisotropy: the horizontal direction means any direction perpendicular to the axis of symmetry of the tilted transverse isotropy (TTI) medium and the vertical direction means a direction along the axis of symmetry of the TTI medium (e.g., the vertical and horizontal directions are defined, for example, at each location on the computational grid). In some circumstances, a TTI medium can be conceptually obtained by rotating the stiffness tensor of a vertically transverse isotropy at each point in space (e.g., differently at each point in space depending on the heterogeneous direction of the symmetry axis).

The seismic modeling system processes (304) one or more seismic measurements using a set of second-order pseudoacoustic equations applied in accordance with the earth model. In various embodiments, the one or more seismic measurements are field-recorded (e.g., measured by seismic sensors 106, FIG. 1), partially processed, and/or entirely synthetic (e.g., simulated source impulses corresponding to seismic sources 112, FIG. 1, or alternatively simulated source and/or sensor measurements that are simulated without regard to any specific source and/or sensor), or a combination thereof. The set of pseudoacoustic equations includes a first equation describing one or more seismic wavefields and a second equation describing the seismic wavefields.

As an example, the following 2×2 second-order pseudoacoustic systems of differential equations (e.g., coupled equations, sometimes called a “wave-propagator”) provides an approximation to the computationally more expensive fully elastic TTI equations:

∂ₜ²P=C₁₁ΔₕP+(C₁₃+C₄₄)ΔᵥQ+C₄₄ΔP (7)

∂ₜ²Q=(C₁₃+C₄₄)ΔₕP+C₃₃ΔᵥQ+C₄₄ΔₕQ (8)

where P and Q are state variables describing the wavefields. In any event, Δᵥ is a Laplacian operator in the vertical direction normalized by the density of the medium ρ (because Δᵥ is defined with respect to a single direction, it is also referred to and equivalent to a “second-derivative” with respect to the vertical direction); and, Δₕ is a Laplacian operator in the horizontal direction normalized by the density of the medium ρ (i.e., a two-dimensional Laplacian operator). More specifically, Δᵥ and Δₕ are given by the following equations, which also define the manner in which the respective Laplacian operators are normalized by the density of the medium ρ:

$$\begin{matrix}{Δ}_{h} u = {\tilde{\partial }}_{\hat{x}} ( \frac{1}{ρ} {\partial }_{\hat{x}} u ) + {\tilde{\partial }}_{\hat{y}} ( \frac{1}{ρ} {\partial }_{\hat{y}} u ) & ( 9 ) \\ {Δ}_{v} u = {\tilde{\partial }}_{\hat{z}} ( \frac{1}{ρ} {\partial }_{\hat{z}} u ) & ( 10 )\end{matrix}$$

where \hat{z} is a Cartesian direction of the axis of symmetry of the TTI medium and \hat{x}, and ŷ are orthogonal Cartesian directions perpendicular to the axis of symmetry of the TTI medium (u is a placeholder for any suitable operand). The differential operators ∂_{\hat{x}}, ∂_{ŷ}, ∂_{\hat{z}}, \tilde{∂}_{\hat{x}}, \tilde{∂}_{ŷ}, and \tilde{∂}_{\hat{z}} are defined below. The Laplacian operators Δᵥ and Δₕ are related to a “three-dimensional” Laplacian operator Δ_{3D} by:

$$\begin{matrix}{Δ}_{3 D} u = {Δ}_{v} u + {Δ}_{h} u \\ = {\tilde{\partial }}_{\hat{x}} ( \frac{1}{ρ} {\partial }_{\hat{x}} u ) + {\tilde{\partial }}_{\hat{y}} ( \frac{1}{ρ} {\partial }_{\hat{y}} u ) + {\tilde{\partial }}_{\hat{z}} ( \frac{1}{ρ} {\partial }_{\hat{z}} u ) \\ = {\partial }_{x} ( \frac{1}{ρ} {\partial }_{x} u ) + {\partial }_{y} ( \frac{1}{ρ} {\partial }_{y} u ) + {\partial }_{z} ( \frac{1}{ρ} {\partial }_{z} u )\end{matrix} \qquad ( 11 )$$

In the above equations, (x, y, z) refer to the “non-rotated” coordinates (e.g., as specified by axes 108, FIG. 1) and ∂ₓ, ∂_{y}, and ∂_{z} are “normal” partial derivatives along the non-rotated coordinates. Furthermore, in the above equations, the differential operators are defined as follows (e.g., the following operators achieve a rotation with respect to the non-rotated coordinates):

∂_{\hat{x}}u=cos θ cos φ∂ₓu+cos θ sin φ∂_{y}u−sin θ∂_{z}u (12)

∂_{ŷ}u=−sin φ∂ₓu+cos φ∂_{y}u (13)

∂_{\hat{z}}u=sin θ cos φ∂ₓu+sin θ sin φ∂_{y}u+cos θ∂_{z}u (14)

\tilde{∂}_{\hat{x}}u=∂ₓ(cos θ cos φu)+∂_{y}(cos θ sin φu)−∂_{z}(sin θu) (15)

\tilde{∂}_{ŷ}u=−∂ₓ(sin φu)+∂_{y}(cos φu) (16)

\tilde{∂}_{\hat{z}}u=∂ₓ(sin θ cos φu)+∂_{y}(sin θ sin φu)+∂_{z}(cos θu) (17)

where φ is the azimuthal angle and θ is the dip angle.

It should be understood that the operators Δ_{3D}, Δᵥ, and Δₕ are generalized Laplacian operators due to the inclusion of a buoyancy term given by 1/ρ at the appropriate locations as indicated in the equations above. For ease of explanation, these operators are referred to simply as “Laplacian operators.” Moreover, such embodiments are not intended to limit that claims the follow; when used in the claims, the term “Laplacian” should be construed to include both standard Laplacian operators as well as more general forms such as those above, unless the claims clearly indicate otherwise.

In any event, continuing with the description of method 300, processing the measurements includes propagating (306) the seismic wavefields over a plurality of time-steps in accordance with the set of pseudoacoustic equations. For example, in some embodiments, the one or more measurements are propagated in either a forward time-stepping or reverse time stepping-direction. Alternatively, in some embodiments, a first subset of the one or more measurements is propagated in a forward time-stepping direction and a second subset of the one or more measurements is propagated in the reverse time-stepping direction (e.g., the first subset comprises synthetic source “measurements” and the second subset comprised measured receiver measurements.)

In some embodiments, propagating the seismic wavefield includes calculating (308) the seismic wavefields (e.g., the seismic wavefields described by P and Q) at a plurality of locations within the medium. In some embodiments, the plurality of locations (e.g., sometimes referred to as a “computational grid”) is chosen to avoid spatial dispersion, while the time-steps are chosen in accordance with a stability condition.

For example, in some embodiments, the propagation is realized using a high-order finite differencing algorithm applied to Equations (7) and (8) (e.g., a finite differencing algorithm that is second-order in time and eighth-order in space). In some embodiments, boundary conditions at the edge of the geologic medium (e.g., the edge of the model) are included in the finite differencing algorithm to fully specify the model. For example, in some circumstances (e.g., such as offshore exploration where the top of the geologic medium is water), the boundary conditions include a free-surface boundary condition at the top of the geologic medium (e.g., the surface of the water) and absorbing boundary conditions on the respective sides and bottom of the model.

In some embodiments, an impulse is injected into Equations (7) and (8) and subsequently propagated (e.g., time-stepped) in time in either a forward time direction (e.g., when the impulse corresponds to a known or estimated source signal) or reverse time direction (e.g., when the impulse corresponds to a measured sensor signal). As used herein, the term impulse means an appropriate forcing function for the set of pseudoacoustic equations. For example, in some embodiments, the state variable P corresponds to a pressure wavefield and, moreover, can be decomposed into a response function \hat{P}( r̅, t) (where r̅=(x, y, z) and t is time) and a forcing function ƒ( r̅, t) such that P=\hat{P}+ƒ. In some such circumstances, the forcing function ƒ( r̅, t) can be written:

ƒ( r̅,t)=γδ( r̅− r̅₀)ƒₛ(t) (18)

where γ is a scaling factor, r̅₀ is a location of a respective seismic source or a respective seismic sensor, δ is the Dirac delta function, and ƒₛ (t) is the source or sensor signal corresponding to the respective seismic source or the respective seismic sensor.

In some circumstances, the forward modeling comprises a migration when an impulse is propagated in either the forward time direction or the reverse time direction to a respective time when the impulse is reflected by a geological feature. In some embodiments, a source signal is propagated in the forward time direction to a respective time and a sensor signal is propagated in a reverse time direction to the respective time in a process known as reverse time migration (RTM). A correlation between a result of the forward time propagation and a result of the reverse time propagation (e.g., a cross-correlation of the results, or a convolution of the results) is used to produce an image of the geologic medium.

Processing the measurements further includes determining (314) whether a respective time-step of the plurality of time-steps meets predetermined criteria. In some embodiments, determining whether the respective time-step of the plurality of time-steps meets the predetermined criteria includes determining (316) whether a number of the respective time-step modulo a first predefined number of time-steps is equal to a predefined value. For example, in some embodiments, every 1,000th time-step meets the predetermined criteria. This can be expressed mathematically as:

A=t_{YES}(mod 1,000) (19)

where A is the predefined value (e.g., 0, 1, 2, 3, etc.), and t_{YES} indicates that the time-step meets the predefined criteria. As described below, this allows the seismic wavefields to be “reset” every 1,000 time-steps, which limits the growth of instabilities. It should be understood, however, that the first predefined number may take on any value (e.g., 500, 2,000, etc.)

In some embodiments, determining whether the respective time-step of the plurality of time-steps meets the predetermined criteria further includes determining (318) whether the number of the respective time-step is greater than a second predefined number of time-steps (e.g., t_{YES}>B, where B is the second predefined number).

In some embodiments, determining whether a respective time-step of the plurality of time-steps meets the predetermined criteria includes (320): calculating (322) an error metric associated with the respective time-step and comparing (324) the error metric associated with the respective time-step to a predefined error threshold. For example, the seismic modeling system may calculate an error metric that corresponds to instability growth and compare the error metric to the predefined error threshold in order to determine whether one or more seismic wavefields are becoming unstable beyond an acceptable level.

It should be understood that the criteria described above (e.g., with respect to operations 316-324) may be used alone or may be combined logically (e.g., using a logical operator such as “AND,” “OR,” etc).

In accordance with a determination that the respective time-step meets the predetermined criteria, the seismic modeling system applies (326) a set of constraints distinct from the earth model and the set of pseudoacoustic equations to adjust the seismic wavefields. This operation is sometimes referred to as a “reset” operation as it limits the growth of instabilities.

For example, in some circumstances, the earth model comprises (328) a tilted transverse isotropic model and applying the set of constraints includes applying constraints consistent with an elliptically anisotropic model. In some embodiments, the seismic wavefields includes (330) a first seismic wavefield and a second seismic wavefield and applying the set of constraints includes enforcing a proportionality between the first seismic wavefield and the second seismic wavefield:

Q=αP (20)

where α is a proportionality constant relating to the elliptical anisotropy. In some embodiments, α is related to the Thomsen parameter ε by the relation:

$$α = \frac{1}{\sqrt{1 + 2 ε}} \qquad ( 21 )$$

In some embodiments, a is equal to unity. This situation is sometimes referred to as “isotropic constraints.”

In some embodiments, there are (336) at least two ways of enforcing a proportionality between the first seismic wavefield and the second seismic wavefield, which may be used separately or in combination. For example, a proportionality can be enforced (337) between the first seismic wavefield and the second seismic wavefield across the entire earth model at a subset of the plurality of time-steps, and there is a predefined time gap of multiple time-steps between any two adjacent time-steps among the subset. But within a sub-region of the earth model that can be treated as elliptical isotropy, a proportionality can be enforced (338) between the first seismic wavefield and the second seismic wavefield at a subset of consecutive time-steps within the plurality of time-steps.

In some embodiments, processing one or more seismic measurements includes performing (331) reverse-time migration to the adjusted one or more seismic wavefields to generate a seismic image of the geologic medium.

FIG. 4 is a schematic flowchart of a method 400 of mitigating instabilities in a pseudoacoustic model, in accordance with some embodiments. The method is, optionally, governed by instructions that are stored in computer memory or a non-transitory computer readable storage medium (e.g., memory 212 in FIG. 2) and that are executed by one or more processors (e.g., processor(s) 202) of one or more computer systems, including, but not limited to, signal processing unit 128 (FIG. 1) and/or system 200 (FIG. 2). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various embodiments, some operations in each method may be combined and/or the order of some operations may be changed from the order shown in the figures. Also, in some embodiments, operations shown in separate figures and/or discussed in association with separate methods (e.g., method 300, FIG. 3 and/or method 800, FIGS. 8A-8C) may be combined to form other methods, and operations shown in the same figure and/or discussed in association with the same method may be separated into different methods. Moreover, in some embodiments, one or more operations in the methods are performed by modules of system 200 shown in FIG. 2, including, for example, processor(s) 202, seismic modeling module 220, memory 212, network interface 210, and/or any sub modules thereof.

The seismic modeling system provides (402) an earth model for a geologic medium. The geologic medium has a heterogeneous tilted symmetry axis, and the earth model includes a nonzero shear velocity in the direction of the symmetry axis for at least a subset of locations within the geologic medium. The earth model may include any combination of pressure wave and shear wave velocities, anisotropy parameters (e.g., a direction of the symmetry axis) and/or one or more values of a stiffness tensor C described above with reference to Equation (1).

The seismic modeling system processes (404) one or more seismic measurements using a set of second-order pseudoacoustic equations applied in accordance with the earth model. In various embodiments, the one or more seismic measurements are field-recorded (e.g., measured by seismic sensors 106, FIG. 1), partially processed, and/or entirely synthetic (e.g., simulated source impulses corresponding to seismic sources 112, FIG. 1, or alternatively simulated source and/or sensor measurements that are simulated without regard to any specific source and/or sensor), or a combination thereof. The set of pseudoacoustic equations includes a first equation (e.g., Equation (7)) describing one or more seismic wavefields and a second equation (e.g., Equation (8)) describing the seismic wavefields.

Processing the seismic measurements includes propagating (406) the seismic wavefields over a plurality of time-steps in accordance with the set of pseudoacoustic equations. Propagating the seismic wavefields includes calculating the seismic wavefields at a plurality of locations within the geologic medium. For example, in some embodiments, the one or more measurements are propagated in either a forward time-stepping or reverse time stepping-direction. Alternatively, in some embodiments, a first subset of the one or more measurements is propagated in a forward time-stepping direction and a second subset of the one or more measurements is propagated in the reverse time-stepping direction (e.g., the first subset comprises synthetic source “measurements” and the second subset comprised measured receiver measurements.)

For a subset of the plurality of locations within the geologic medium, upon completion of each time-step in the plurality of time-steps, the seismic modeling system applies (408) a set of constraints distinct from the earth model and the set of pseudoacoustic equations to adjust the seismic wavefields (e.g., any of the constraints described above with reference to method 300). In some embodiments, the subset of the plurality of locations within the geologic medium includes locations in the geologic medium that comprise at least one of water and/or salt (e.g., the subset of the plurality of locations in the computational grid are the regions of the geologic medium which do not support shear waves and/or tilted transverse isotropy). In some embodiments, the seismic wavefields are “reset” after every time-step at the subset of the plurality of locations.

FIG. 5 illustrates several simulated wavefield snapshots calculated in accordance with some embodiments. In particular, the panel 500-1 and panel 500-2 are both wavefield snapshots calculated by injecting a wavelet into Equations (7) and (8) and propagating the corresponding wavefield to a time T=4 seconds after injection of the wavelet (e.g., injection of the wavelet simulates an impulse from a seismic source). The difference between panel 500-1 and panel 500-2 is that the wavefield in panel 500-2 is calculated by applying elliptical constraints (e.g., applying Equation (14), referred to as a “reset” operation) every 1,000 time-steps (in this example, a time-step is equal to 0.7 milliseconds), while no reset operation is used for the wavefield in panel 500-1. Panel 500-3 illustrates a calculated difference between the wavefields in panel 500-1 and panel 500-2 (for clarity, the difference is multiplied by a factor of 10 in the panel 500-3).

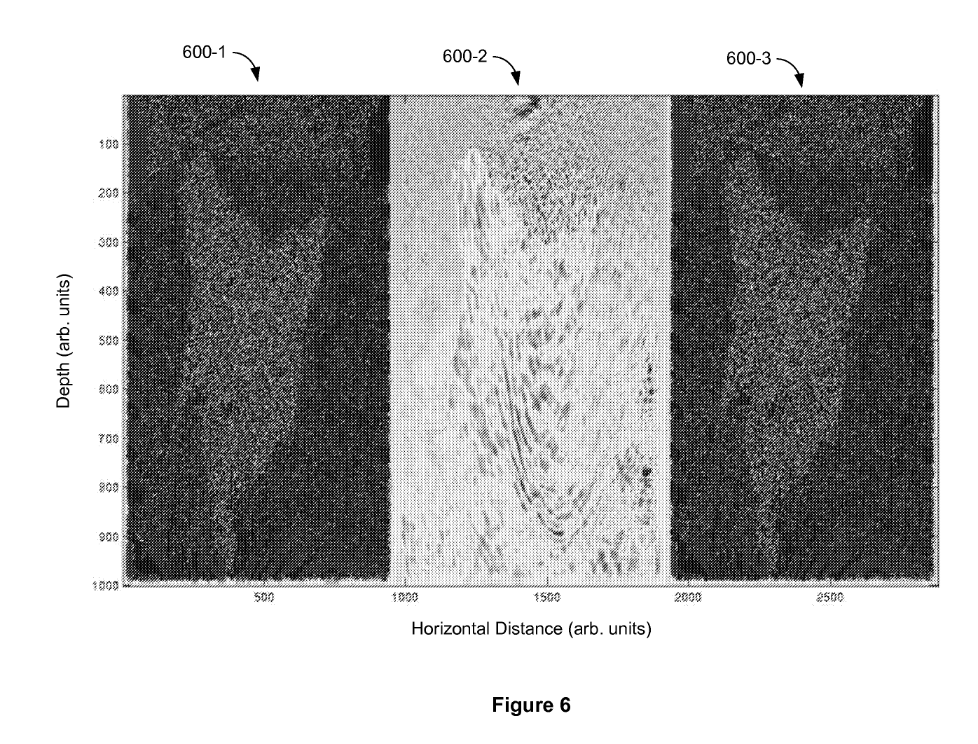

FIG. 6 illustrates several simulated wavefield snapshots calculated in accordance with some embodiments. In particular, panel 600-1 and panel 600-2 illustrate the same scenarios as panel 500-1 and panel 500-2 (FIG. 5), however, in panel 600-1 and 600-2 the respective wavefields have been time-stepped to a time T=12 seconds after injection of the wavelet (as compared to T=4 seconds in panel 500-1 and 500-2). Panel 600-3 illustrates a calculated difference between the wavefields in panel 600-1 and panel 600-2 (for clarity, the difference is multiplied by a factor of 10 in the panel 600-3).

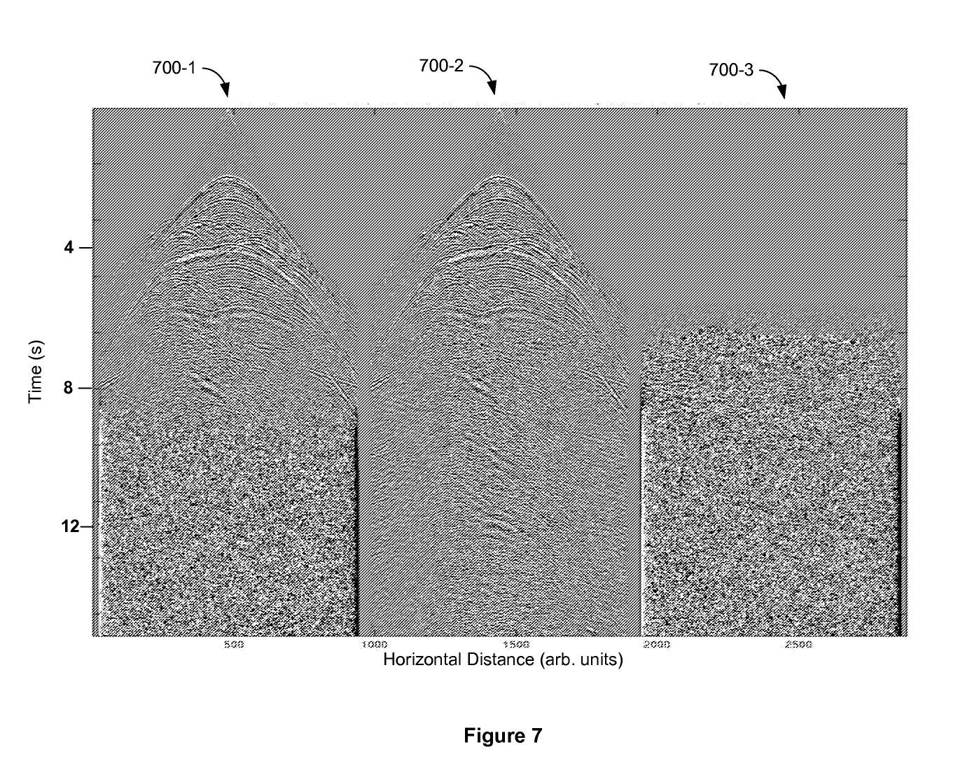

FIG. 7 illustrates several simulated pre-stack images (shown with corrections for spherical divergence) calculated in accordance with some embodiments. In particular, the panel 700-1 illustrates a pre-stack image in which each vertical column represents a trace that would be received by a seismic sensor positioned at the corresponding horizontal location. The panel 700-2 also illustrates a pre-stack image in which each vertical column represents a trace that would be received by a seismic sensor positioned at the corresponding horizontal location. The difference between panel 700-1 and panel 700-2 is that the pre-stack image in panel 700-2 is calculated by applying elliptical constraints (e.g., applying Equation (13), referred to as a “reset” operation) every 1,000 time-steps (in this example, a time-step is equal to 0.7 milliseconds), while no reset operation is used for the pre-stack image in panel 700-1. Panel 700-3 illustrates a calculated difference between the pre-stack images in panel 700-1 and panel 700-2 (for clarity, the difference is multiplied by a factor of 10 in the panel 700-3). It is clear from the images that an instability grows in time without the reset operation, and that the instability renders the pre-stack image in panel 700-1 ineffective after a time of approximately 8 seconds. By comparison, the image in panel 700-2 remains clear well-past 8 seconds, which in turn implies useful information at greater depths of the geologic medium.

FIGS. 8A-8C is a schematic flowchart of a method 300 of mitigating instabilities in a pseudoacoustic model, in accordance with some embodiments. The method is, optionally, governed by instructions that are stored in computer memory or a non-transitory computer readable storage medium (e.g., memory 212 in FIG. 2) and that are executed by one or more processors (e.g., processor(s) 202) of one or more computer systems, including, but not limited to, signal processing unit 128 (FIG. 1) and/or system 200 (FIG. 2). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various embodiments, some operations in each method may be combined and/or the order of some operations may be changed from the order shown in the figures. Also, in some embodiments, operations shown in separate figures and/or discussed in association with separate methods (e.g., method 300, FIG. 3, method 400, FIG. 4) may be combined to form other methods, and operations shown in the same figure and/or discussed in association with the same method may be separated into different methods. Moreover, in some embodiments, one or more operations in the methods are performed by modules of system 200 shown in FIG. 2, including, for example, processor(s) 202, seismic modeling module 220, memory 212, network interface 210, and/or any sub modules thereof.

The seismic modeling system receives (802) one or more seismic measurements corresponding to a plurality of source and receiver locations (e.g., seismic sensors 106 and/or seismic sources 112, FIG. 1). In some embodiments, the seismic modeling system receives one or more seismic measurements corresponding to a plurality of receiver locations and also receives one or more simulated source impulses corresponding to a plurality of source locations. The simulated source impulses are simulated representations of real impulses (e.g., impulses released from seismic sources 112) that propagate through the geologic medium (e.g., including water) and whose corresponding wavefields are received and measured by seismic sensors 106, thus resulting in the seismic measurements. For ease of explanation, the term “seismic measurements” should be understood to include both measurements from seismic sensors and simulated impulses from seismic sources. This is because, in some circumstances, the two are handled (e.g., processed and/or propagated through the geologic medium) in an analogous manner. In various embodiments, the one or more seismic measurements are field-recorded (e.g., measured by seismic sensors 106, FIG. 1), partially processed, and/or entirely synthetic (e.g., simulated source impulses corresponding to seismic sources 112, FIG. 1, or alternatively simulated source and/or sensor measurements that are simulated without regard to any specific source and/or sensor), or a combination thereof.

The seismic modeling system provides (804) an earth model for a geologic medium (e.g., a geologic medium that includes strata 118 and/or exemplary formation 124, FIG. 1). The geologic medium has a heterogeneous tilted symmetry axis, and the earth model includes a nonzero shear velocity in the direction of the symmetry axis. In some embodiments, the earth model is stored in a non-transitory computer readable storage medium (e.g., memory 212 in FIG. 2) of the seismic modeling system and is provided by the seismic modeling system to one or more processors (e.g., processor(s) 202, FIG. 2) for processing. In some embodiments, method 800 is performed iteratively and the earth model is updated between iterations (e.g., in accordance with an error metric). In some embodiments, the seismic modeling system receives the earth model from a remote system (e.g., a server) which may be land-based (e.g., in the event that the seismic modeling system is aboard a seafaring vessel). In some embodiments, the earth model comprises (806) a tilted transverse isotropic model. The earth model may include any combination of pressure wave and shear wave velocities, anisotropy parameters (e.g., a direction of the symmetry axis) and/or one or more values of a stiffness tensor C described above with reference to Equation (1).

The seismic modeling system propagates (808) the seismic measurements over a plurality of time-steps in accordance with the earth model and a set of energy-conservative pseudoacoustic equations. For example, in some embodiments, the one or more measurements are propagated in either a forward time-stepping or reverse time stepping-direction. Alternatively, in some embodiments, a first subset of the one or more measurements is propagated in a forward time-stepping direction and a second subset of the one or more measurements is propagated in the reverse time-stepping direction (e.g., the first subset comprises synthetic source “measurements” and the second subset comprised measured receiver measurements.)

The set of energy-conservative pseudoacoustic equations includes a first equation (e.g., Equation (37)) describing one or more seismic wavefields and a second equation (e.g., Equation (38)) describing the seismic wavefields. Moreover, the set of energy-conservative pseudoacoustic equations is derived (810) from a set of energy non-conservative pseudoacoustic equations by approximating one or more derivative terms of the seismic wavefields in the set of energy non-conservative pseudoacoustic equations.

Consider the following non-limiting example in which a set of energy-conservative pseudoacoustic equations describing one or more seismic wavefields is derived from a set of energy non-conservative pseudoacoustic equations. Equations (7) and (8) constitute a set of energy non-conservative pseudoacoustic equations and can be re-written using the Thomsen parameters and the ƒ-value in the following form:

$$\begin{matrix}{\partial }_{t}^{2} P = {C}_{33} \{ ( f + 2 ε ) {Δ}_{h} P + \sqrt{f ( f + 2 δ )} {Δ}_{v} Q + ( 1 - f ) {Δ}_{3 D} P \} & ( 22 ) \\ {\partial }_{t}^{2} Q = {C}_{33} \{ \sqrt{f ( f + 2 δ )} {Δ}_{h} P + f {Δ}_{v} Q + ( 1 - f ) {Δ}_{3 D} Q \} & ( 23 )\end{matrix}$$

In some embodiments, the seismic wavefields include (812) a first seismic wavefield and a second seismic wavefield. One or more of the first seismic wavefield and the second seismic wavefield comprise a linear combination of a pressure wavefield and a shear wavefield. A new wavefield M, which comprises a linear combination of wavefield P and wavefield Q, is introduced to further simplify Equations (22) and (23):

$$M = \frac{( f + 2 ε ) Q - \sqrt{f ( f + 2 δ )} P}{\sqrt{2 f ( ε - δ )}} \qquad ( 24 )$$

Differentiating Equation (24) twice with respect to time yields:

$${\partial }_{t}^{2} M = \frac{( f + 2 ε ) {\partial }_{t}^{2} Q - \sqrt{f ( f + 2 δ )} {\partial }_{t}^{2} P}{\sqrt{2 f ( ε - δ )}} \qquad ( 25 )$$

Equation (24) can be written equivalently (i.e., by algebraically solving for Q) as:

$$Q = \frac{\sqrt{f ( f + 2 δ )} P + \sqrt{2 f ( ε - δ )} M}{( f + 2 ε )} \qquad ( 26 )$$

Applying a Laplacian derivative A (e.g., any of the group consisting of Δ_{3D},

Δₕ, and/or Δ_{y}) to Equation (26) yields:

$$Δ Q = Δ ( \frac{\sqrt{f ( f + 2 δ )} P + \sqrt{2 f ( ε - δ )} M}{( f + 2 ε )} ) \qquad ( 27 )$$

As noted above, the set of energy-conservative pseudoacoustic equations is derived by approximating one or more derivative terms of the seismic wavefields. In some embodiments, the approximated derivative terms include (814) one or more Laplacian derivative terms. In some embodiments, the approximated derivative terms include (816) at least one derivative term along a respective direction that is approximated by treating an anisotropy parameter as constant with respect to the respective direction. For example, the following Laplacian derivative terms can be approximated by treating the anisotropy parameters ε and δ as constant with respect to any or all directions (e.g., 1, 2, or 3 distinct Cartesian spatial directions):

$$\begin{matrix}Δ ( \frac{\sqrt{f ( f + 2 δ )}}{( f + 2 ε )} P ) \approx \frac{\sqrt{f ( f + 2 δ )}}{( f + 2 ε )} Δ P & ( 28 ) \\ Δ ( \frac{\sqrt{2 f ( ε - δ )}}{( f + 2 ε )} M ) \approx \frac{\sqrt{2 f ( ε - δ )}}{( f + 2 ε )} Δ M & ( 29 )\end{matrix}$$

Thus, Equation (27) is approximated by:

$$Δ Q \approx \frac{\sqrt{f ( f + 2 δ )} Δ P + \sqrt{2 f ( ε - δ )} Δ M}{( f + 2 ε )} \qquad ( 30 )$$

Using the above approximations, the set of equations consisting of Equations (22) and (23) can be expressed in the following approximated form, albeit still as a set of energy non-conservative pseudoacoustic equations:

$$\begin{matrix}{\partial }_{t}^{2} P = {C}_{33} [ ( f + 2 ε ) {Δ}_{h} P + \sqrt{f ( f + 2 δ )} {Δ}_{v} Q + ( 1 - f ) {Δ}_{3 D} P ] & ( 31 ) \\ {\partial }_{t}^{2} M = {C}_{33} [ \sqrt{2 f ( ε - δ )} {Δ}_{v} Q + ( 1 - f ) {Δ}_{3 D} M ] & ( 32 )\end{matrix}$$

Continuing with approximations to one or more derivative terms of the seismic wavefields, in some embodiments, a respective one of the approximated derivative terms is (818) a Laplacian derivative of a respective one of the seismic wavefields and the respective one of the approximated derivative terms is approximated by approximating the Laplacian derivative of the respective one of the seismic wavefields with a term that includes a Laplacian derivative involving one or more anisotropy parameters (e.g., the Laplacian derivative operates on an operand that includes one or more anisotropy parameters). For example, the following three-dimensional Laplacian derivative term for u (e.g., where u is a placeholder for P or M) can be approximated as follows:

$$( 1 - f ) {Δ}_{3 D} u \approx ( f + 2 ε ) \sqrt{\frac{1 - f}{f + 2 ε}} {Δ}_{3 D} ( \sqrt{\frac{1 - f}{f + 2 ε}} u ) \qquad ( 33 )$$

This results in the following set of energy-conservative pseudoacoustic equations:

$${\partial }_{t}^{2} P = {C}_{33} [ ( f + 2 ε ) {Δ}_{h} P + \sqrt{f ( f + 2 δ )} {Δ}_{v} Q + ( f + 2 ε ) \sqrt{\frac{1 - f}{f + 2 ε}} {Δ}_{3 D} ( \sqrt{\frac{1 - f}{f + 2 ε}} P ) ] \qquad ( 34 )$$

$$\begin{matrix}{\partial }_{t}^{2} M = {C}_{33} [ \sqrt{2 f ( ε - δ )} {Δ}_{v} Q + ( f + 2 ε ) \sqrt{\frac{1 - f}{f + 2 ε}} {Δ}_{3 D} ( \sqrt{\frac{1 - f}{f + 2 ε}} M ) ] & ( 35 ) \\ Q = \frac{\sqrt{f ( f + 2 δ )} P + \sqrt{2 f ( ε - δ )} M}{( f + 2 ε )} & ( 36 )\end{matrix}$$

As can be seen above, in some embodiments, propagating the seismic measurements includes (820) calculating four second-order derivatives (e.g., exactly four), including:
a two-dimensional Laplacian derivative of a first seismic wavefield with respect to an anisotropy plane, the anisotropy plane being locally perpendicular to the symmetry axis (e.g., ΔₕP, Equation (34));
a three-dimension Laplacian derivative of a term corresponding to the first seismic wavefield

$$( e . g . , {Δ}_{3 D} ( \sqrt{\frac{1 - f}{f + 2 ε}} P ) ,$$

### Equation (34));

a three-dimension Laplacian derivative of a term corresponding to second seismic wavefield

$$( e . g . , {Δ}_{3 D} ( \sqrt{\frac{1 - f}{f + 2 ε}} M ) ,$$

### Equation (35)); and

a second-order derivative of a third seismic wavefield with respect to a direction of the symmetry axis (e.g., ΔᵥQ, Equation (35)).

The third seismic wavefield is a linear combination of the first seismic wavefield and the second seismic wavefield (e.g., as indicated by Equation (36)).

It should be noted that an equivalent set of energy-conservative pseudoacoustic equations (e.g., equivalent to Equation (37) and (38)). can be expressed as follows, in accordance with some embodiments:

$$\begin{matrix}{\partial }_{t}^{2} P = {C}_{33} [ ( f + 2 ε ) {Δ}_{h} P + \sqrt{f ( f + 2 δ )} {Δ}_{v} ( \frac{\sqrt{f ( f + 2 δ )} P + \sqrt{2 f ( ε - δ )} M}{( f + 2 ε )} ) + ( f + 2 ε ) \sqrt{\frac{1 - f}{f + 2 ε}} {Δ}_{3 D} ( \sqrt{\frac{1 - f}{f + 2 ε}} P ) ] & ( 37 ) \\ {\partial }_{t}^{2} M = {C}_{33} [ \sqrt{2 f ( ε - δ )} {Δ}_{v} ( \frac{\sqrt{f ( f + 2 δ )} P + \sqrt{2 f ( ε - δ )} M}{( f + 2 ε )} ) + ( f + 2 ε ) \sqrt{\frac{1 - f}{f + 2 ε}} {Δ}_{3 D} ( \sqrt{\frac{1 - f}{f + 2 ε}} M ) ] & ( 38 )\end{matrix}$$

In the case of Equations (37) and (38), propagating the seismic measurements includes calculating five second-order derivatives (e.g., exactly five), including:
a two-dimensional Laplacian derivative of a first seismic wavefield with respect to an anisotropy plane, the anisotropy plane being locally perpendicular to the symmetry axis (e.g., ΔₕP, Equation (37));
a three-dimension Laplacian derivative of a term corresponding to the first seismic wavefield

$$( e . g . , {Δ}_{3 D} ( \sqrt{\frac{1 - f}{f + 2 ε}} P ) ,$$

### Equation (37));

a three-dimension Laplacian derivative of a term corresponding to second seismic wavefield

$$( e . g . , {Δ}_{3 D} ( \sqrt{\frac{1 - f}{f + 2 ε}} M ) ,$$

### Equation (38)); and

a second-order derivative of a term corresponding to the first seismic wavefield with respect to a direction of the symmetry axis

$$( e . g . , {Δ}_{v} ( \sqrt{\frac{f ( f + 2 δ )}{( f + 2 ε )}} P ) ,$$

### Equation (37) and (38)).

a second-order derivative of a term corresponding to the second seismic wavefield with respect to a direction of the symmetry axis

$$( e . g . , {Δ}_{v} ( \sqrt{\frac{2 f ( ε - δ )}{( f + 2 ε )}} M ) ,$$

### Equation (37) and (38)).

In some embodiments, propagating the seismic wavefields includes (822) calculating the seismic wavefields at a plurality of locations within the geologic medium at each time-step of the plurality of time-steps (e.g., calculating three seismic wavefields using Equations (34)-(36) and/or calculating two seismic wavefields using Equation (37) and (38)). In some embodiments, propagating the seismic measurements further includes (824) performing reverse-time migration to the seismic wavefields.

An alternative set of energy-conservative pseudoacoustic equations can also be derived as:

$$\begin{matrix}{\partial }_{t}^{2} P = {C}_{33} [ ( f + 2 ɛ ) {Δ}_{h} P + \sqrt{f ( f + 2 δ )} {Δ}_{v} Q + ( f + 2 ɛ ) {\sum }_{j = 1}^{3} {\partial }_{j} ( \frac{1}{ρ} \frac{1 - f}{f + 2 ɛ} {\partial }_{j} ( P ) ) ] & ( 39 ) \\ {\partial }_{t}^{2} M = {C}_{33} [ \sqrt{2 f ( ɛ - δ )} {Δ}_{v} Q + ( f + 2 ɛ ) {\sum }_{j = 1}^{3} {\partial }_{j} ( \frac{1}{ρ} \frac{1 - f}{f + 2 ɛ} {\partial }_{j} ( M ) ) ] & ( 40 )\end{matrix}$$

The system of Equations (39) and (40) also conserves full energy and is therefore stable. It can also be shown that this system of equations is, in some circumstances, more robust for earth model parameter variations in preserving the original system amplitudes. This system of equations differ from Equations (37) and (38) in that the Laplacian operators acting on

$$\frac{1 - f}{f + 2 ɛ} - scaled$$

wavefields mere are replaced by applying the

$$\frac{1 - f}{f + 2 ɛ}$$

term between the two first-order derivatives (such as ∂ⱼ) resulting in different, more robust amplitude-scaling properties for a wider range of anisotropy parameters.

In some circumstances, each of the seismic wavefields is (826) characterized at each of the plurality of time-steps by a respective energy stored therein. For each time-step of the plurality of time-steps, a sum of the respective energies stored in the seismic wavefields is constant. In this manner, the set of pseudoacoustic equations is a set energy-conservative of pseudoacoustic equations.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising:
providing an earth model for a geologic medium, the geologic medium having a heterogeneous tilted symmetry axis, wherein the earth model includes a nonzero shear velocity in the direction of the symmetry axis for at least a subset of locations within the geologic medium;
processing one or more seismic measurements corresponding to a plurality of source and receiver locations using a set of second-order pseudoacoustic equations applied in accordance with the earth model, the set of pseudoacoustic equations including a first equation describing one or more seismic wavefields and a second equation describing the one or more seismic wavefields, wherein the processing includes:
propagating the one or more seismic wavefields over a plurality of time-steps in accordance with the set of pseudoacoustic equations;
determining whether a respective time-step of the plurality of time-steps meets predetermined criteria; and
in accordance with a determination that the respective time-step meets the predetermined criteria, applying a set of constraints distinct from the earth model and the set of pseudoacoustic equations to adjust the one or more seismic wavefields.

2. The method of claim 1, wherein:
the earth model comprises a tilted transverse isotropic model; and
applying the set of constraints includes applying constraints consistent with an elliptically anisotropic model.

3. The method of claim 2, wherein:
the one or more seismic wavefields includes a first seismic wavefield and a second seismic wavefield; and
applying the set of constraints includes enforcing a proportionality between the first seismic wavefield and the second seismic wavefield.

4. The method of claim 3, wherein enforcing a proportionality between the first seismic wavefield and the second seismic wavefield includes one selected from the group consisting of (i) enforcing a proportionality between the first seismic wavefield and the second seismic wavefield across the entire earth model at a subset of the plurality of time-steps, and there is a predefined time gap of multiple time-steps between any two adjacent time-steps among the subset, and (ii) enforcing a proportionality between the first seismic wavefield and the second seismic wavefield within a sub-region of the earth model at a subset of consecutive time-steps within the plurality of time-steps.

5. The method of claim 1, wherein propagating the one or more seismic wavefields includes calculating the one or more seismic wavefields at a plurality of locations within the medium at a predefined time.

6. The method of claim 1, wherein determining whether the respective time-step of the plurality of time-steps meets the predetermined criteria includes determining whether a number of the respective time-step modulo a first predefined number of time-steps is equal to a predefined value.

7. The method of claim 6, where determining whether the respective time-step of the plurality of time-steps meets the predetermined criteria further includes determining whether the number of the respective time-step is greater than a second predefined number of time-steps.

8. The method of claim 1, wherein determining whether a respective time-step of the plurality of time-steps meets the predetermined criteria includes:
calculating an error metric associated with the respective time-step; and
comparing the error metric associated with the respective time-step to a predefined error threshold.

9. The method of claim 1, wherein processing one or more seismic measurements further includes performing reverse-time migration to the adjusted one or more seismic wavefields.

10. An electronic device, comprising:
one or more processors;
memory; and
one or more programs, wherein the one or more programs are stored in the memory and configured to be executed by the one or more processors, the one or more programs including instructions that when executed by the one or more processors cause the device to:
provide an earth model for a geologic medium, the geologic medium having a heterogeneous tilted symmetry axis, wherein the earth model includes a nonzero shear velocity in the direction of the symmetry axis for at least a subset of locations within the geologic medium;
process one or more seismic measurements using a set of second-order pseudoacoustic equations applied in accordance with the earth model, the set of pseudoacoustic equations including a first equation describing one or more seismic wavefields and a second equation describing the one or more seismic wavefields, wherein the processing includes:
propagating the one or more seismic wavefields over a plurality of time-steps in accordance with the set of pseudoacoustic equations;
determining whether a respective time-step of the plurality of time-steps meets predetermined criteria; and
in accordance with a determination that the respective time-step meets the predetermined criteria, applying a set of constraints distinct from the earth model and the set of pseudoacoustic equations to adjust the one or more seismic wavefields.

11. The electronic device of claim 10, wherein:
the earth model comprises a tilted transverse isotropic model; and
applying the set of constraints includes applying constraints consistent with an elliptically anisotropic model.

12. The electronic device of claim 11, wherein:
the one or more seismic wavefields includes a first seismic wavefield and a second seismic wavefield; and
applying the set of constraints includes enforcing a proportionality between the first seismic wavefield and the second seismic wavefield.

13. The electronic device of claim 12, wherein enforcing a proportionality between the first seismic wavefield and the second seismic wavefield includes one selected from the group consisting of (i) enforcing a proportionality between the first seismic wavefield and the second seismic wavefield across the entire earth model at a subset of the plurality of time-steps, and there is a predefined time gap of multiple time-steps between any two adjacent time-steps among the subset, and (ii) enforcing a proportionality between the first seismic wavefield and the second seismic wavefield within a sub-region of the earth model at a subset of consecutive time-steps within the plurality of time-steps.

14. The electronic device of claim 10, wherein propagating the seismic wavefield includes calculating the one or more seismic wavefields at a plurality of locations within the medium.

15. The electronic device of claim 10, wherein determining whether the respective time-step of the plurality of time-steps meets the predetermined criteria includes determining whether a number of the respective time-step modulo a first predefined number of time-steps is equal to a predefined value.

16. The electronic device of claim 15, wherein determining whether the respective time-step of the plurality of time-steps meets the predetermined criteria further includes determining whether the number of the respective time-step is greater than a second predefined number of time-steps.

17. The electronic device of claim 10, wherein determining whether a respective time-step of the plurality of time-steps meets the predetermined criteria includes:
calculating an error metric associated with the respective time-step; and
comparing the error metric associated with the respective time-step to a predefined error threshold.

18. The electronic device of claim 10, wherein processing one or more seismic measurements further includes performing reverse-time migration to the adjusted one or more seismic wavefields.

19. A non-transitory computer readable storage medium storing one or more programs, the one or more programs comprising instructions, which when executed by an electronic device with one or more processors and memory, cause the device to:
provide an earth model for a geologic medium, the geologic medium having a heterogeneous tilted symmetry axis, wherein the earth model includes a nonzero shear velocity in the direction of the symmetry axis for at least a subset of locations within the geologic medium;
process one or more seismic measurements using a set of second-order pseudoacoustic equations applied in accordance with the earth model, the set of pseudoacoustic equations including a first equation describing one or more seismic wavefields and a second equation describing the one or more seismic wavefields, wherein the processing includes:
propagating the one or more seismic wavefields over a plurality of time-steps in accordance with the set of pseudoacoustic equations;
determining whether a respective time-step of the plurality of time-steps meets predetermined criteria; and
in accordance with a determination that the respective time-step meets the predetermined criteria, applying a set of constraints distinct from the earth model and the set of pseudoacoustic equations to adjust the one or more seismic wavefields.

20. A computer-implemented method, comprising:
providing an earth model for a geologic medium, the geologic medium having a heterogeneous tilted symmetry axis, wherein the earth model includes a nonzero shear velocity in the direction of the symmetry axis;
processing one or more seismic measurements using a set of second-order pseudo-acoustic equations applied in accordance with the earth model, the set of pseudo-acoustic equations including a first equation describing one or more seismic wavefields and a second equation describing the one or more seismic wavefield, wherein the processing includes:
propagating the one or more seismic wavefields over a plurality of time-steps in accordance with the set of pseudo-acoustic equations, wherein propagating the one or more seismic wavefield includes calculating the one or more seismic wavefields at a plurality of locations within the geologic medium;
for a subset of the plurality of locations within the geologic medium, upon completion of each time step in the plurality of time-steps, applying a set of constraints distinct from the earth model and the set of pseudo-acoustic equations to adjust the one or more seismic wavefields.
